(19) United States
(12) Patent Application Publication
(10) Pub. No.: US 2005/0000902 A1
(43) Pub. Date: Jan. 6, 2005

(54) System for reclaiming water softener brine waste

(75) Inventors: John Van Newenhizen, Mundelein, IL (US); Frank A. Brigano, Hoffman Estates, IL (US)

Correspondence Address: GREER, BURNS & CRAIN, 300 S WACKER DR, 25TH FLOOR, CHICAGO, IL, 60606, US

(73) Assignee: USF Consumer & Commercial WaterGroup, Inc.

(21) Appl. No.: 10/612,633

(22) Filed: Jul. 2, 2003

(51) Int. Cl. C02F 1/42

(52) U.S. Cl. 210/670; 210/737; 210/96.1

(57) ABSTRACT

A method of reclaiming brine waste in a water softener having an inlet, a service water outlet, a wastewater outlet, and having a brine/rinse cycle in which brine solution is directed through a resin bed and to a drain, includes measuring a TDS or specific ion level of the solution exiting the wastewater outlet during the brine/rinse cycle, comparing the measured TDS or specific ion level with a preset value, and diverting the flow of water out the outlet to a reclamation location once the measured TDS exceeds the preset value. A waste reclamation unit includes a housing in fluid communication with the water softener and at least one waste reservoir, a compressor, a compressor coil, a control unit configured for sensing the introduction of liquid into the reservoir and for triggering the compressor; and a collection pan configured for collecting water condensing on the coil and preventing the entry of water into the waste reservoir.

### BACKGROUND OF THE INVENTION

The present invention relates generally to water treatment devices such as water softeners, and particularly to a system for reducing the amount of wastewater having a high total dissolved solids (TDS) concentration which is typically sent to the drain during the operation of the water treatment device.

Hard water causes problems such as scaling, spotting, soap scum, irritated/dry skin, poor laundry performance and others. Ion exchange water softeners are used to remove calcium (Ca⁺⁺) and magnesium (Mg⁺⁺), commonly known as the “hardness” elements for the hard scale deposits they can cause. Softeners do this using the natural preferential exchange of sodium (Na⁺) or potassium (K⁺) ions for those of the hardness elements. It is also possible to use this process for the removal of other troublesome multi-valent ions such as iron (Fe⁺⁺) and manganese (Mn⁺⁺). Once the sodium ions have been exchanged off the resin by the hardness ions (given up their site to the more highly charged ions), the softener needs to have this naturally preferred process reversed. This is accomplished by overcoming the naturally favored exchange by using a large excess of sodium or potassium ions to drive the reaction the other way. As a constant flow of excess sodium or potassium ions moves through the ion exchange resin bed, the hardness elements are pushed off as waste along with the excess sodium or potassium. Finally, as the resin is rinsed, the resin exchange sites each hold one sodium or potassium ion. The equipment is then returned to service for the reduction of more hardness ions.

Theoretically, it is possible to regenerate every exchange site on the resin by using large amounts of salt, resulting in an absolute maximum capacity. Practically, this is not done because the amount of regenerating salt that would be required is excessive compared to the gain in capacity. Efficiency is measured by determining the amount of hardness removed for each pound of salt used to regenerate it back to the sodium or potassium form. During regeneration, each pound of salt used is increasingly less effective than the previous one. Modern ion exchange softeners are regenerated at dosages intended to be efficient rather than for the most hardness removed per regeneration. Equipped with demand type regeneration devices and adjusted for the most efficient salt dosages, they can be designed to reach over 70% of maximum theoretical capacities.

In 2002, California law required new softeners to have an efficiency rating of 4,000 grains hardness removed for each pound of salt used in regeneration, up from averages of only 2,000 grains for softeners in the 1980s into 1990s. Even with these substantial gains in efficiencies and the resulting decrease in the amount of high TDS wastewater discharged during regeneration, some municipal systems are unable to allow this increase in the TDS of their wastewater. This can be due to waste treatment plant discharge permits or the intended uses for reclaim water such as irrigation of sensitive crops. Some areas have banned self-regenerating water softeners.

Most of the research efforts to date on a “saltless” water softener have involved total dissolved solids (“TDS”) reduction processes like reverse osmosis, nanofiltration, distillation, continuous deionization, capacitive deionization, or others. These processes do reduce hardness, but they are not selective for hardness like the ion exchange process. They also reduce other dissolved solids present along with the hardness elements. Therefore, all of these TDS reduction processes are limited in the amount of product water they can recover due to the water chemistry of the influent supply. The solubility of the various dissolved ion species present in the feed water will determine how much reduced TDS product water can be recovered before precipitation will occur, causing scale to form. In a reverse osmosis system, the precipitation would cause a failure. On some feed water sources it may only be possible to recover 50% as product water without causing precipitation to occur. The advantage of these TDS reduction systems in reducing hardness without the use of salt is compromised by the issues of water conservation and cost. There have also been recent concerns about the TDS concentrated in the waste stream created by these processes.

Water demands in a household environment are sporadic. There are periods of high demand for showers, laundry, dishwashing, etc. and long periods of no demand. TDS reduction systems proposed for household use would need to be relatively large, complex and expensive to meet peak demand flow rates. Due to these design requirements and inherent drawbacks of large on-demand systems, most designs have typically been storage and repressurization systems. The latter system treats water and transfers it into a large reservoir that is then used to deliver product water at the required demand rates.

As discussed above, a water softener reduces hardness by exchanging one ion for another. In the case of current water softening technology, this means the exchange of sodium or potassium ions on the resin contained in the softener tank for the incoming calcium or magnesium “hardness” ions. This process is an equal charge-for-charge exchange. The TDS level of the feed water and the product water are essentially the same, only the mix of ions present has been changed. The water has been “softened” now that the “hardness” ions have been removed. In the service cycle, a water softener recovers 100% of the feed water as product water. Only the backwash/brine/rinse cycles used to renew the resin exchange sites in the regeneration cycle produce any wastewater. The overall product water recovery of the service/regeneration cycle is typically over 90% and often over 95% depending on the incoming hardness level and the design of the system. A softener also handles the wide range of water flow demands in a household environment without the need for a storage and repressurization system.

Alternate hardness reduction technologies have been researched, tested and applied. None of these processes have been shown to be as effective, safe, reliable, or economical as ion exchange water softening. The weakness of ion exchange softeners, and the reason for legislation against their use in some communities is the high TDS of the regeneration waste. It is not a health hazardous waste; rather it is only too salty for some secondary uses such as irrigation or for discharge to sensitive streams. Different secondary uses and different communities may have different maximum allowable TDS discharge levels.

Thus, there is a need for a brine waste treatment system for use with a water softener which reduces or eliminates the release of high TDS regeneration water to drain. There is also a need for such a system where the apparatus requires limited floor space and is relatively inexpensive. Such an apparatus may also be considered for installation indoors or outdoors.

### BRIEF SUMMARY OF THE INVENTION

The above-listed needs are met or exceeded by the present system for water softener brine waste recovery, which features a method and apparatus for treating the liquid brine waste from a self-regenerating household water softener for disposal. The invention uses the system of evaporation and condensation in the preferred embodiment, to separate water from an undesirable solid. The high TDS liquid waste is processed into a solid form that can be disposed of as common household refuse. Ideally, a user places regeneration salt in one container and removes hardness and sodium salt solid waste from another container.

The present system will prevent the potential overloading of downstream waste treatment processes with high liquid TDS levels during regeneration, particularly sodium or potassium chloride salts. Further, the present system will enable the use of effective hardness-reducing, ion exchange water softening equipment, even in areas currently troubled with a high TDS load in wastewater.

More specifically, the present invention provides a method of reclaiming brine waste in a water softener having an inlet, a product or service water outlet and a wastewater outlet, the operation of the softener including a brine/rinse cycle in which brine solution is directed through a resin bed of the softener to the wastewater outlet and ultimately to a drain. The method includes measuring a TDS or specific ion level of the solution generally adjacent the wastewater outlet during the brine/rinse cycle, comparing the measured TDS or specific ion level with a locally required maximum preset value or a value determined from that of the inlet water, and diverting the flow of water out the wastewater outlet away from the drain to a reclamation location once the measured TDS exceeds this desired or preset value. Alternately, TDS levels may be interpreted from signals given by a pair of conductivity sensors located inside the softener near the bottom of the resin bed.

In addition, a waste reclamation unit is provided for use with a water softener for reclaiming high TDS regeneration solution and preventing the discharge of that solution to drain. The unit includes a housing in fluid communication with the water softener and including at least one reservoir, a compressor associated with the housing and including at least one coil, a control unit associated with the housing and configured for sensing the introduction of liquid into the reservoir and for triggering the compressor; and a collection pan disposed in operational relationship to the at least one coil and configured for collecting water condensing on the at least one coil, directing the low TDS condensed water to drain and preventing the re-entry of evaporated/condensed water into the reservoir.

Further, the present system provides for redirecting very low hardness brine at the end of a regeneration cycle back to the brine making system. This reclamation of regenerant brine can reduce the volume of liquid high TDS solution to be treated by the waste brine system. However, the practice of redirecting brine for reuse may be accomplished independently of the waste brine system to save salt, improve softener regeneration efficiency and reduce high TDS waste to drain.

### BRIEF DESCRIPTION OF THE SEVERAL VIEWS OF THE DRAWINGS

FIG. 1 is an elevational view of a conventional water softener system suitable for use with the present brine reclamation system;

FIG. 2 is a fragmentary schematic vertical section of a first embodiment of the present brine reclamation device;

FIG. 3 is a front view of the device of FIG. 2;

FIG. 4 is a rear view of the device of FIG. 2; and

FIG. 5 is a fragmentary elevational view of an alternate embodiment of the present brine reclamation system.

### DETAILED DESCRIPTION OF THE INVENTION

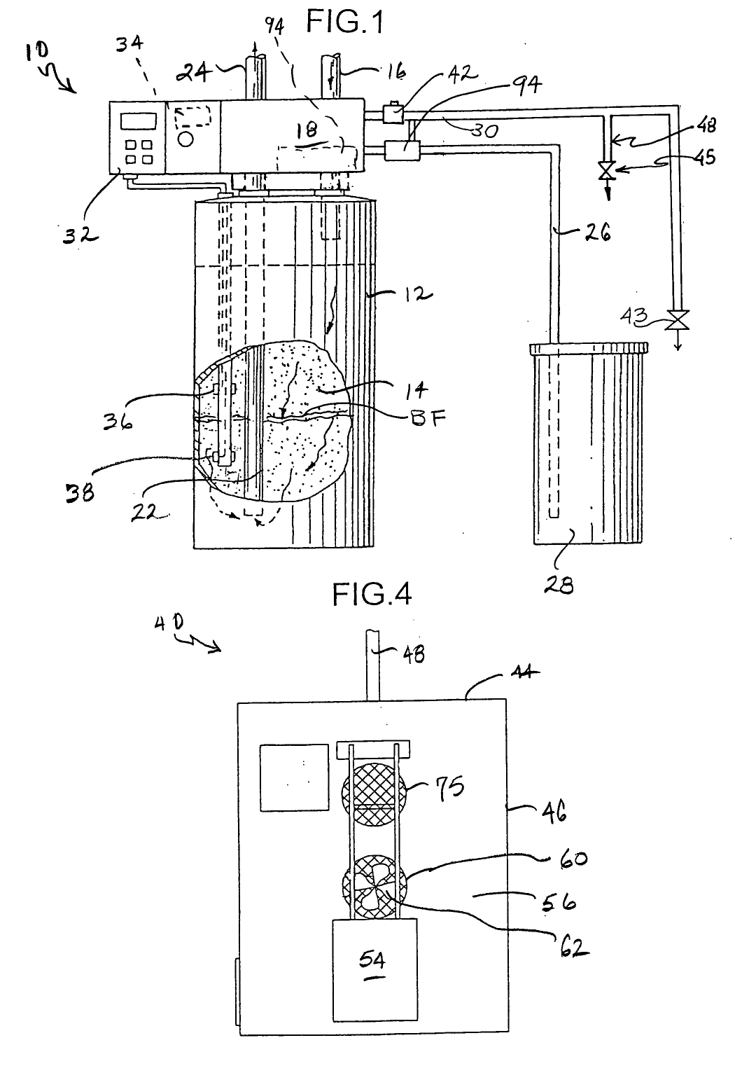

Referring to FIG. 1, a water conditioning or softening apparatus suitable for use with the present system is generally designated 10 and includes a water tank or main treatment tank 12 containing a bed 14 of suitable ion exchange resin. In the service cycle, a water supply line 16 is connected via a valve housing 18 which passes the water into the tank 12. The water is softened as it passes down through the bed 14 and is removed via a pipe 22 through the valve housing 18 to a line 24 which supplies the softened water to the water system. A conduit 26 extends from the valve housing 18 to a brine tank 28 which contains salt and water for forming the brine. A drain conduit 30 is also connected to the valve housing 18 and is connected to a suitable drain (not shown). A control unit 32 is mounted adjacent the valve housing for controlling the operation of the valve which diverts water as required during operation of the softener 10. As is typical in such control units, a microprocessor 34 (shown hidden) is included in the control unit 32.

As is well known in the art, the softener 10 operates most of the time in a service cycle, in which feed water flows through the resin bed 14 and is softened. Softened water is emitted out the line 24. After a certain amount of water has been softened, set by the user based on consumption rates, hardness of feed water, and other factors known to those skilled in the art, the resin bed 14 must be regenerated to discharge the hardness ions collected on the resin beads and replaces them with sodium or potassium ions.

The following describes a typical regeneration sequence for a water softener. First, a backwash step is conducted, in which feed water enters the tank 12 in reverse direction to flush out particles filtered in the service cycle and to loosen the resin bed 14 so that it is not overly compacted. The next step is brine/draw and brine/rinse. This step has two functions. The first is to introduce brine into the treatment tank 12 from the brine tank 28 via the conduit 26. Brine is drawn into the treatment tank 12 for a number of minutes or until a mechanical brine valve (not shown) in the brine tank 28 discontinues the brine draw. At that time, a slow rinse cycle begins. The resin bed 14 of the water softener 10 is surrounded totally by sodium or potassium ions. As hard water used in the slow rinse enters the tank through the conduit 16, it starts to form a low sodium/high sodium front at the top of the tank 12. This front will gradually advance downward towards the bottom of the tank 10 pushing the high TDS liquid out.

As is described in commonly assigned U.S. Pat. No. 5,699,272, incorporated by reference herein, pairs of sensing and reference electrodes 36, 38, connected to the microprocessor 34, can be used to monitor the progress of the front towards the bottom of the tank 12. The electrode pairs 36, 38 are vertically spaced relative to each other for detecting the impedance difference of the solution in the water tank between the electrodes 36 which form a sensing cell Rs and the electrodes 38 which form a reference cell Rr. The monitoring of this front is preferably used to determine when the slow rinse cycle has concluded. It will also be noted that the electrodes 38 are in close operational proximity to a lower end of the conduit 22, through which flows both treated water out conduit 24 and water intended for the drain through conduit 30, depending on the position of the valve in the valve housing 18. Upon conclusion of the slow rinse cycle, a fast rinse/refill cycle is completed and the softener 10 returns to the service cycle. However, as described below, the signals from these electrodes 36, 38 may also be used to monitor the TDS level of the water in the tank 12. The rinse out of high TDS solution may also be monitored with a conductivity sensor 42 located in drain conduct 30.

A typical household water softener with one cubic foot of ion exchange resin produces 40-75 gallons of liquid to drain per regeneration. The regeneration frequency of a softener is dependent on water use and hardness, but typically occurs 1-2 times a week. The challenge is to control the type and amount of liquid waste, thereby reducing the volume of high dissolved solids water to be treated for disposal.

To characterize the liquid waste produced by a typical softener, the amount and chemistry of each regeneration step must be analyzed. Although the exact flow rates, timing and order of regeneration steps vary between systems designs, the following descriptions are typical for a 1 cubic foot system:

| | | FLOW RATE | TO | |
|---|---|---|---|---|
| STEP | TIME | Gallons per | DRAIN | TDS LEVEL |
| NAME | Minutes | Minute | Gallons | PPM |
| Backwash | 5-10 | 1.5-2 | 7-20 | Same as inlet |
| Brine Draw | 20-40 | 0.3-0.5 | 5-20 | Same as inlet, |
| | | | | increasing to High |
| Rinse | 20-30 | 0.4-0.5 | 8-15 | High, then |
| | | | | declining to same |
| | | | | as inlet |
| Final Rinse | 5-10 | 1.5-2 | 7.5-20 | Same as inlet |

Control of each cycle and sending acceptable TDS liquid directly to drain without treatment reduces the cost/size of the waste treatment system. There is little or no impact on the incoming TDS level for the regeneration waste produced in the Backwash or the Final Rinse steps. These steps and their associated liquid volumes could be controlled to discharge directly to drain since there is no TDS concentration occurring. That leaves only the 13-35 gallons of liquid waste produced in Brine Draw and Rinse to control/treat. It is anticipated that improvements in regeneration efficiency could further reduce this volume.

An analysis of the TDS levels at drain during these steps shows that there is a lag before the high TDS liquid gets to the drain at the start of Brine Draw. This is due to the displacement of the water already in the resin tank. Conventional water softeners continue to send this liquid with an acceptable TDS level to the normal household drain. Effective monitoring and control of the wastewater will result in less liquid to handle with the brine waste treatment system.

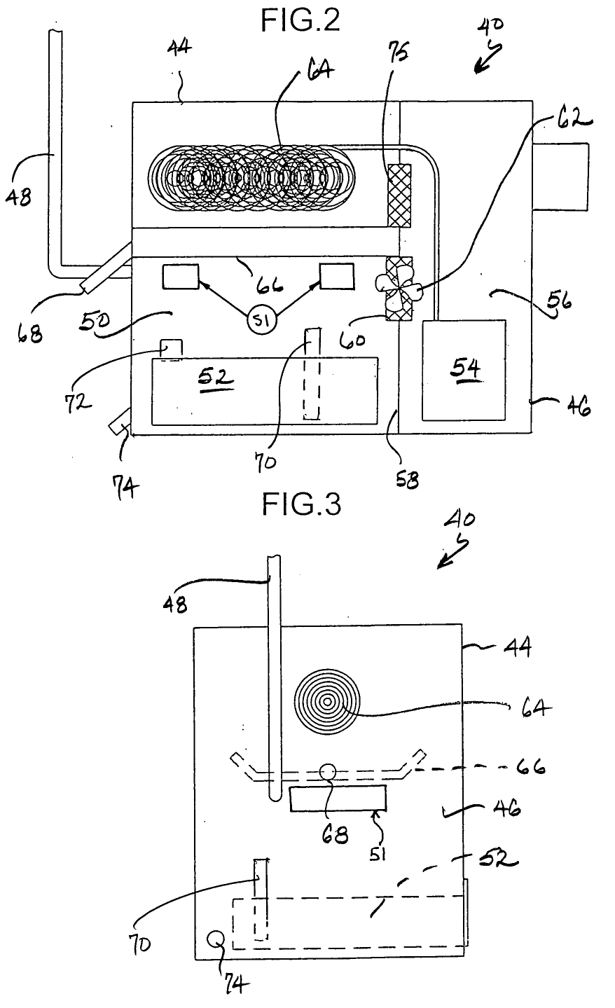

Referring now to FIGS. 2-4, to minimize the amount of high TDS level water to drain, the present system, generally designated 40, provides a way for the undesirable high TDS wastewater to be diverted from the household drain, stored and concentrated for separate disposal as household refuse. TDS values are preferably interpreted from the signals given by the electrode pairs 36, 38, as described above, which are also connected to the microprocessor 34. A diversion threshold value may vary to suit the application, or the regulations of a specific locality. Alternately, a TDS sensor or an ion specific electrode 42 is placed in the conduit 30 where it exits the valve, through which water will flow to the drain outlet 30. This sensor 42 is connected to the microprocessor 34, which measures sensed TDS or specific ion values and compares them with preset values, as is known in the art.

At a point in the Brine Draw step when the TDS or specific measured ions exceeds the diversion threshold or the acceptable limit of TDS in the softener discharge, the controller 32, and specifically the microprocessor 34 will signal a drain valve 43 and a divert valve 45 to divert the high TDS liquid from the softener 10 into the present waste reduction device 44, which serves as the brine reclamation location. This diversion to the device 44 continues as long as, and until the control 32 senses, through the signals from the electrodes 36 and 38 or the sensor 42, a return to an acceptable discharge TDS level.

An advantage of the present system 40 is that using the electrodes 36 and 38 or the sensor 42 with the control 32 to only divert the high TDS regeneration waste for treatment, reduces the total volume of liquid that requires treatment for alternate disposal. Only the lower TDS water from the regeneration steps that is not a burden to the downstream waste treatment plant or the environment is released to the drain.

The basic function of the waste reduction device 44 is to evaporate the water from the collected high TDS material. This serves to concentrate the remaining solids so that they can easily be discarded. To achieve these goals, the device 44 includes a housing 46 having an inlet 48 in fluid communication with the drain conduit 30 of the water softener 10. The housing 46 defines a reservoir chamber 50 configured for retaining at least one removable, and preferably disposable reservoir 52. A compressor 54 is preferably associated with the housing 46, and in the preferred embodiment is located in a compressor chamber 56 adjacent, but separated from, the reservoir chamber 50. A partition 58 separates the compressor chamber 56 from the reservoir chamber 50. An aperture 60 in the partition 58 is provided with a fan 62 disposed to vent hot air from the compressor chamber 56 into the reservoir chamber 50. This venting enhances the evaporation of the liquid in the reservoir 52.

At least one compressor coil 64 is connected to the compressor 54 as is known in the art and is preferably disposed above the reservoir 52. Separating the coil 64 from the reservoir 52 is a collection pan 66 disposed to collect low TDS water droplets condensing upon the coil 64. The pan 66 is preferably inclined so that collected water may be removed via a discharge outlet 68. As best seen in FIG. 3, it will be appreciated that the pan 66 is narrower than the housing 46 to allow for the free flow of water vapor upward towards the coil 64. It is also contemplated that the discharge outlet 68 is connected to drain, however it is also contemplated that a collection container (not shown) may be provided for retaining and reusing the low TDS condensed water. The latter essentially is now distilled water. It is also anticipated that a reclamation system could be located outside in some geographical regions. Such system may not require a compressor and coils since the evaporated water vapor could be released directly to the atmosphere.

A liquid sensor 70 serves as the reservoir control unit, is disposed in operational relationship to the reservoir 52 and monitors the presence of liquid or solids build-up in the reservoir. Suitable liquid sensors 70 include float switches, optical switches, spring-loaded weight switches or other types of sensors capable of generating a signal upon the presence of liquid or a solids build-up in the reservoir 52. The compressor 54 may be alternately be energized by the control unit 32 upon water being diverted from the drain conduit 30 and into the inlet 48. Also, the reservoir 52 is preferably sized to accommodate in excess of the amount of solution generated during the cyclical diversion, which is expected to be in the range of 10-20 gallons.

Typically high TDS liquid diverted from the softener tank 12 travels through the drain conduit 30, is diverted by the valves 43 and 45 under the control of the microprocessor 34 (signaled by the TDS sensor 42 or the electrodes 36 and 38) to the inlet 48 and ultimately into the reservoir 52. Upon entry into the reservoir 52, the liquid sensor 70 or the microprocessor 34 energizes the compressor 54 which then cools the at least one coil 64. In so doing, the compressor 54 generates heat, which is preferably passed by the fan 62 into the reservoir chamber 50 to enhance the evaporation of the liquid from the reservoir 52. It is contemplated that other sources of heat or other evaporation enhancers 51 (FIGS. 2 and 3) may be provided, including but not limited to solar heaters, exhaust fans, incandescent bulbs, heater coils and the like. The water vapor emitted by the reservoir condenses on the coil 64.

Once the solution in the reservoir 52 is evaporated, which can be determined by the humidity level inside the housing 46, the weight of the reservoir, the level of a float switch, the optical density of the contents of the reservoir, the passage of time or other known technique, the compressor 54 is deenergized. The remaining solids are collected in the reservoir after successive cycles, and preferably disposed of as a solid with normal household refuse. It is contemplated that the collected solids may be emptied from the reservoir 52 for disposal, or that the entire reservoir is disposable.

An optional overflow or reservoir full sensor 72 (FIG. 2) may be provided with, or in operational proximity to the reservoir 52 to gauge the flow of liquid in the brine inlet 48 or gauge the need for the reservoir 52 to be replaced/emptied. Upon triggering of the sensor 72, the flow from the treatment tank 12 is terminated, or the regeneration step is cancelled. Furthermore, the overflow sensor 72 may be connected to a visual and/or audible alarm (not shown). An overflow outlet 74 is provided for draining excess water which may spill over the reservoir 52. A return air screen 75 may be provided to stabilize airflow between the compressor chamber 56 and the coils 64.

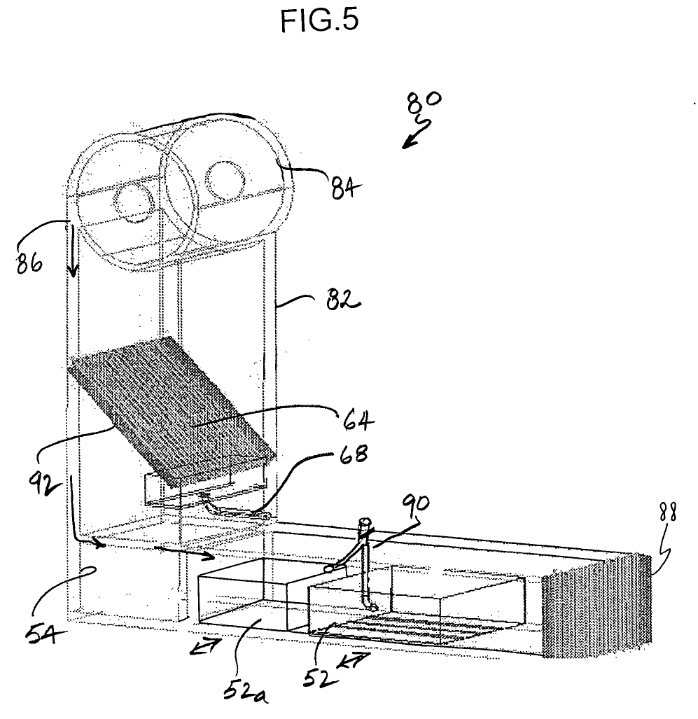

Referring now to FIG. 5, another embodiment of the reclamation device is generally designated 80. Shared components with the reclamation device 44 have been designated with the same reference numbers. Also, it is contemplated that the devices 44, 80 may each include equipment and/or features described for the other in the present application. The main difference between the device 80 and the device 44 is that a generally “L”-shaped housing 82 has been provided for a more compact arrangement of the components. Such a model could be used where household space is at a premium.

A rotary or “squirrel cage” fan 84 is located at an upper end 86 of the housing 82 and pulls air through the device past warm coils 88. The warmed air aids in the evaporation of the waste brine in the two reservoirs 52, 52a. The use of one reservoir 52 is also contemplated, and it is also contemplated that the device may have multiple reservoirs. A conventional “Y” diverter fitting 90 may be used to alternate flow to either reservoir 52, 52a. Upon becoming filled with the collected sediment, the reservoirs 52, 52a may be removed from the chamber by a lateral, drawer-like sliding action or removed through an opening in the top of the device.

Below the fan 84 is an inclined cooling panel 92 bearing the coil 64. The warmed moist air condenses on the coils and collects in a pan for disposal through discharge outlet 68. In this embodiment, the compressor 54 is located external to the device 80, or beneath the cooling panel 92. It will be appreciated that other configurations of these components may be provided and still achieve the benefits of the collection, evaporation, condensation and reclamation of water and solids from softener regeneration discharge.

Another aspect of the present system relates to the previously described characteristics of the various waste solutions coming from the softener during regeneration. As has been noted, as the brine solution first enters the treatment tank 12, the first liquid to waste is treated water. The next liquid component is mixed brine and the discharged calcium and magnesium ions. This component is the prime object of the present diversion reclamation system, since it has the highest undesirable TDS levels and dislodged hardness levels. The last part of this brine component is disposed behind a brine front and is relatively hardness-free, pure sodium or potassium chloride, since the resin media 14 has been regenerated at this point and cannot take up any more sodium or potassium ions. Further, the calcium and magnesium ions have been substantially eliminated.

To reduce the amount of liquid sent to the reclamation unit 40, and also to prevent the discharge of this substantially pure brine to drain, it is contemplated that the present system is configurable for conservation of the brine. Specifically, the brine front BF (FIG. 1) is monitored in the tank 12, and, upon the front reaching the bottom of the tank, the drain conduit 30 is connected, as by a diverter valve 94 under the control of the control unit 32, to the brine tank 28 for reuse in the next regeneration. In this manner, the salt consumed by the softener 10 is also reduced.

One way in which the movement of the brine front BF is monitored is by the electrodes 36, 38, which sense the change in conductivity of the two solutions, first the high TDS calcium, magnesium and brine regeneration solution, and second, the relatively low TDS brine solution. The TDS or specific ion monitor 42 may also be considered as a technique for monitoring when diversion should be initiated. The diversion to the brine tank 28 continues until the desired amount of liquid has been returned. If the electrodes 36 and 38 or the TDS or specific ion sensor 42 sense that the TDS of the outgoing solution is then below the acceptable discharge level, it is diverted directly to the drain through valve 43. If an acceptable level has not been reached, the wastewater is then diverted to the present waste reclamation system 40 through the valve 45, until an acceptable level is achieved.

It is obvious that any steps taken to reduce the amount of liquid diverted to the invention would reduce the time/energy needed to turn it into a disposable solid. Optimization of resin tank design, distribution, brine flow rates, brine strengths times, steps, resin types would all enhance the value and performance of this system.

One concept would be the use of higher concentration brine for regeneration. Salt dosages used in conventional softeners are fine-tuned to meet brine regeneration efficiency requirements. With the present device, it may be more energy and cost efficient to focus on reducing the amount of liquid to treat due to low cost and availability of salt. The cost of removing the water from the high TDS waste may exceed the cost of using additional salt. A balance between the cost of waste disposal and the gallons of product water provided per pound of salt used would need to be examined. With this invention, any additional salt used in an effort to reduce liquid volume is efficiently disposed of as a solid and not released to any downstream wastewater treatment plants.

The goal of treating the high TDS waste from the regeneration of a water softener is to finish with a safely disposable solid. The water needs to be selectively removed from the solids dissolved in it. A number of options in an industrial or municipal application involve the use of hazardous chemicals, precipitation, filter presses, waste heat, and others. These are not realistic options for use in a household environment. The process needs to be simple and cost effective.

The present system uses the processes of evaporation and condensation to first separate and then capture the water portion of the softener regeneration waste. This condensed low TDS wastewater can be safely released to drain, and the resulting solid waste product left behind after evaporation can be disposed of as normal household waste. In addition, the present system can be sized to provide the separation of the anticipated waste volume to the number of days between regeneration. Therefore, if the softener only produces 15 gallons of waste every 4-5 days, the present system could be sized to have 2-3 days of time to evaporate/condense and recover the water to drain from the waste. This would mean smaller and more cost efficient systems could be used.

While a particular embodiment of the present system for reclaiming water softener brine waste has been described herein, it will be appreciated by those skilled in the art that changes and modifications may be made thereto without departing from the invention in its broader aspects and as set forth in the following claims.

1. A method of reclaiming brine waste in a water softener having an inlet, a service water outlet and a wastewater outlet, the operation of the softener including a brine/rinse cycle in which brine solution is directed through a resin bed of the softener to the wastewater outlet and ultimately to a drain, said method comprising:
measuring a TDS or specific ion level of the solution generally adjacent the wastewater outlet during the brine/rinse cycle;
comparing the measured TDS or specific ion level with one of a preset value and a value determined from the inlet water; and
diverting the flow of water out the wastewater outlet away from the drain to a reclamation location once the measured TDS exceeds the preset value.

2. The method of claim 1 further including continuing the measuring of the TDS or specific ion level of the solution generally adjacent the wastewater outlet and diverting the flow until the measured TDS or specific ion level falls below the preset value.

3. The method of claim 1 wherein the water softener includes a brine tank, and further including monitoring a brine front in the treatment tank, and diverting the water flow from the outlet to the brine tank approximately when the brine front reaches the outlet.

4. The method of claim 3 further including continuing the measuring of the TDS or specific ion level of the solution exiting the wastewater outlet and diverting the flow until the measured TDS or specific ion level falls below the preset value, then sending the flow to drain.

5. The method of claim 1 further including evaporating the water from the solution at the reclamation location.

6. The method of claim 5 further including sensing the presence of the solution at the reclamation location, energizing a compressor to cool a condensing mechanism, heating the solution with heat generated by the compressor, and collecting water condensing upon the condensing mechanism.

7. The method of claim 6 further including sensing the completed evaporation of the diverted solution and deenergizing the compressor.

8. The method of claim 6 further including collecting the remaining solids for disposal.

9. The method of claim 1 further including providing one of TDS level determination using sensing and reference electrode pairs for monitoring TDS level of the water exiting in the softener as waste.

10. The method of claim 1 wherein said reclamation location is a brine tank.

11. The method of claim 1 wherein said reclamation location is a storage tank where the liquid is collected and taken to an alternate location for treatment and disposal.

12. A waste reclamation unit configured for use with a water softener for reclaiming high TDS solution and preventing the discharge of that solution to drain, said unit comprising:
a housing in fluid communication with the water softener and including at least one waste reservoir;
a compressor associated with said housing and including at least one coil;
a control unit associated with said housing and configured for sensing the introduction of liquid into said reservoir and for triggering said compressor; and
a collection pan disposed in operational relationship to said at least one coil and configured for collecting water condensing on said at least one coil and preventing the entry of said water into said waste reservoir.

13. The unit of claim 12 wherein said housing includes separate waste reservoir and compressor chambers respectively for said reservoir and said compressor, and further including means for transferring heat generated by said compressor into said waste reservoir chamber.

14. The unit of claim 13 wherein said means for transferring heat is a fan, an infrared heater, a heat lamp, a heating pad, a ceramic heater, or heating strips/tape.

15. The unit of claim 12 further including an outlet on said housing in fluid communication with said collection pan.

16. The unit of claim 12 wherein said at least one coil and said collection pan are disposed in said housing above said waste reservoir.

17. The unit of claim 12 wherein said at least one waste reservoir is removable.

18. The unit of claim 17 wherein said at least one waste reservoir is disposable.

19. The unit of claim 12 further including a supplemental removable waste reservoir.

20. The unit of claim 12 further including an overflow or reservoir full sensor configured for sensing the level of liquid or solids in said at least one waste reservoir and energizing at least one of an alarm signal and a cutoff signal to the softener.
